(19) United States
(12) Patent Application Publication
(10) Pub. No.: US 2023/0046474 A1
(43) Pub. Date: Feb. 16, 2023

(54) PROCESS AND APPARATUS FOR REMOVING IMPURITIES FROM CRYSTALLIZED METAL SULFATES

(71) Applicant: HATCH LTD., Mississauga (CA)

(72) Inventors: Robert John Fraser, Oakville (CA); Andrew Doolittle, Mississauga (CA); Alexander Sutherland, Mississauga (CA); Adam Best, Mississauga (CA); Firsya Risandi, Mississauga (CA)

(21) Appl. No.: 17/979,502

(22) Filed: Nov. 2, 2022

Related U.S. Application Data
(63) Continuation of application No. PCT/CA2022/050450, filed on Mar. 25, 2022.
(60) Provisional application No. 63/165,806, filed on Mar. 25, 2021.

(51) Int. Cl. C01G 53/10

(52) U.S. Cl. CPC C01G 53/10; C01P 2006/40

(57) ABSTRACT

A process for removing impurities from a crystallized metal sulfate, including contacting crystallized metal sulfate with a liquor rich in metal sulfate. The metal may be cobalt, nickel, or manganese, and the impurities may be magnesium or calcium. The liquor rich in metal sulfate may be an overflow liquor from crystallization of the metal sulfate, and said overflow liquor may be subject to one or more impurities removal steps prior to contacting the crystallized metal sulfate, such that the overflow liquor contains lower levels of impurities than the crystallized metal sulfate to be contacted. A counter-current wash circuit may be used to remove impurities from a crystallized metal sulfate, whereby a plurality of washing tanks are configured to receive crystallized metal sulfate in a sequence, and washing liquor in reverse of said sequence.

### CROSS-REFERENCE TO RELATED APPLICATIONS

This application claims priority to each of U.S. Provisional Patent Application 63/165,806 filed Mar. 25, 2021, and PCT application PCT/CA2022/050450 filed Mar. 25, 2022; the contents of each of which is incorporated herein by reference in its entirety.

### FIELD

The present disclosure relates to processes and methods for producing and purifying crystalized metal sulfates, and in particular, for removing impurities from crystallized metal sulfates.

### BACKGROUND

Climate change is driving electrification of transportation, and as a result, the need for batteries, such as lithium ion batteries (LIBs). Although LIBs are already ubiquitous in society, the total annual consumption is small compared to that which would be required for mass-market electric vehicle adoption. With a growing demand for LIBs, there is a growing demand for the chemicals from which they are produced, particularly battery-grade metal sulfates.

Nickel and cobalt sulfate battery chemicals are commonly produced by separately dissolving nickel metal and cobalt metal with sulfuric acid and conducting purification prior to crystallizing them as battery grade sulfates. This metal dissolution process is performed both by cathode manufacturers and by mining companies that have built sulfate production circuits at their refineries. The metal dissolving pathway from ore to battery requires the expensive steps of either electrowinning or hydrogen reduction to produce London Metal Exchange (LME) grade metal prior to dissolution. This pathway is a major contributor to the premium demanded for battery grade sulfates, mainly nickel sulfate, over metals prices. The industry is moving towards more direct production pathways from concentrate or intermediates to battery chemicals. For example, more direct pathways have already been developed for cobalt chemicals thanks to the maturity of the lithium-cobalt-oxide battery chemistry used in cell phones and electronics.

Further, current battery chemical production processes often include separation of cobalt and nickel via solvent extraction (SX), which enables production of individual battery grade sulfates that meet purity requirements. SX can be very effective in separating metals, but is a relatively complex unit operation, requiring multiple stages of extraction, scrubbing and stripping, and systems for organic treatment of aqueous discharge streams, crud removal, organic vapour recovery, and fire protection. These requirements result in substantial capital costs associated with a commercial scale SX operation. Depending on the number of SX circuits required, the direct costs associated with SX can be more than 30% of the refinery cost.

Processes and methods for achieving high purity crystallized metal sulfates are desirable.

### BRIEF DESCRIPTION OF THE FIGURES

Embodiments of the present disclosure will now be described, by way of example only, with reference to the attached Figures.

FIG. 1 is a schematic diagram of a process for removing impurities from crystalized metal sulfates according to an embodiment of the present disclosure.

FIG. 2 is a schematic diagram of a process for crystallizing cobalt sulfate, and for removing magnesium and calcium impurities therefrom, according to an embodiment of the present disclosure.

FIG. 3 is a schematic diagram of a counter-current wash circuit, according to an embodiment of the present disclosure.

FIG. 4 is a flow diagram of a general process for generating crystallized metal sulfates.

### DETAILED DESCRIPTION

Processes for producing crystallized metal sulfates, particularly of high purity, are desirable. Accordingly, the present disclosure provides processes and apparatus for reducing or removing at least a portion of the impurities from crystallized metal sulfates. The processes may include contacting crystallized metal sulfate with a solution rich in metal sulfate but low in impurities to thereby solubilize impurities in the crystallized metal sulfate, which may be distributed within the crystal lattice. Said solution may be derived from the overflow stream of the metal sulfate crystallizer, which has been treated to reduce or remove at least a portion of the impurities, such that the solution has a lower level of impurities than the crystallized metal sulfate, but the solution is rich in metal sulfate. In such a process, the metal sulfate crystals are not materially redissolved when contacted with the solution, but may be partially dissolved.

The processes and apparatus herein disclosed may be used to reduce or remove at least a portion of the impurities from a crystallized metal sulfate. The crystallized metal sulfate may be produced in a process for generating a crystallized metal sulfate as described herein. It will be understood that the crystallized metal sulfate may be from other suitable sources, including any process that uses evaporative or cooling or heating crystallization to produce crystallized metal sulfate salts.

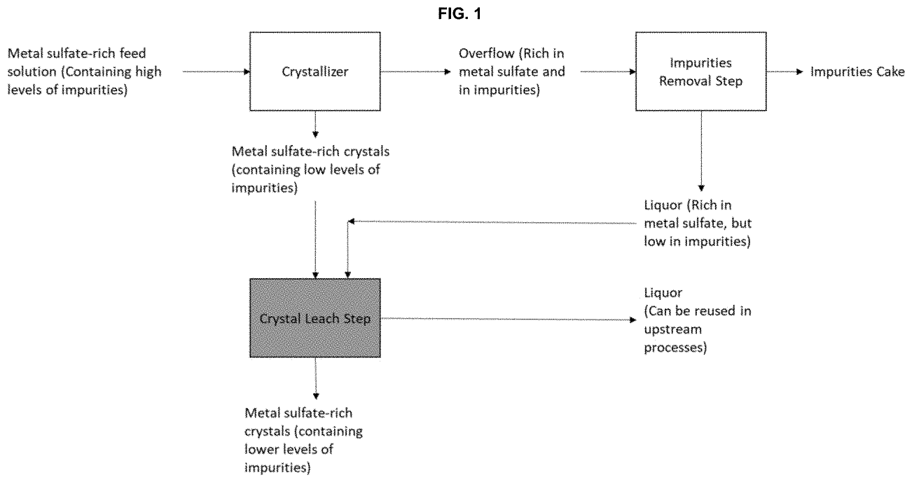

FIG. 1 shows a process for removing impurities from crystallized metal sulfate according to an embodiment of the present disclosure. The metal sulfate may be cobalt sulfate, nickel sulfate, or manganese sulfate. The crystallized metal sulfate may be a metal sulfate hydrate, or any suitable solvated metal sulfate. According to FIG. 1, a metal sulfate-rich feed solution, containing relatively high levels of impurities, may be fed to the crystallizer to give metal sulfate-rich crystals, containing relatively low levels of impurities, and an overflow solution rich in metal sulfate and in impurities. The impurities in the metal sulfate-rich crystals may be distributed within the crystal lattice. The overflow solution may be fed to an impurities removal step. Impurities may include magnesium or calcium. Impurities may include trace metal cations with an oxidation state of +2. Impurities removal may involve the addition of a precipitant, such as sodium fluoride, to induce precipitation of at least a portion of the impurities. Impurities removal may include ion exchange (IX), such as nickel removal by IX from a cobalt liquor, or manganese removal by IX from a cobalt or nickel liquor. Impurities removal may occur before and/or after crystallization. As shown in FIG. 1, following an impurities removal step, a liquor rich in metal sulfate but relatively low in impurities is formed, which may be used in a crystal leach step. Since the metal sulfate concentration in the liquor of FIG. 1 is similar to metal sulfate concentration in the leach step, the metal sulfate crystals are not redissolved. Furthermore, since the level of impurities in the liquor of FIG. 1 is less than the level of impurities in the crystals, the impurities would preferentially go from crystal to liquor.

The process of FIG. 1 therefore yields metal sulfate-rich crystals, containing relatively lower levels of impurities, and a liquor that can be reused as recycled wash liquor elsewhere in the process, or in a related process. The liquor wash may be used in an elutriation leg of the crystallizer, whereby the exiting crystals are washed by the purified liquor wash stream. In such a case, the liquor would pass into the crystallizer. Alternatively or additionally, the liquor wash may be used downstream of the crystallizer as a first or a subsequent wash step of the crystals to help them achieve their target product composition. The liquor wash may be used to dissolve solid metal sulfate, such as to re-dissolve crude metal sulfate for further processing.

In one or more embodiments, the process includes crystallizing a metal sulfate-rich feed solution to form crystals rich in a select metal sulfate and an overflow solution containing metal sulfate and impurities. Crystallizing the metal sulfate-rich feed solution may include preferentially crystallizing the select metal sulfate, relative to alternative metal sulfate salts, from the metal sulfate-rich feed solution. Alternatively, or additionally, the metal sulfate-rich feed solution may be subject to one or more pre-treatment steps prior to crystallization of the select metal sulfate hydrate.

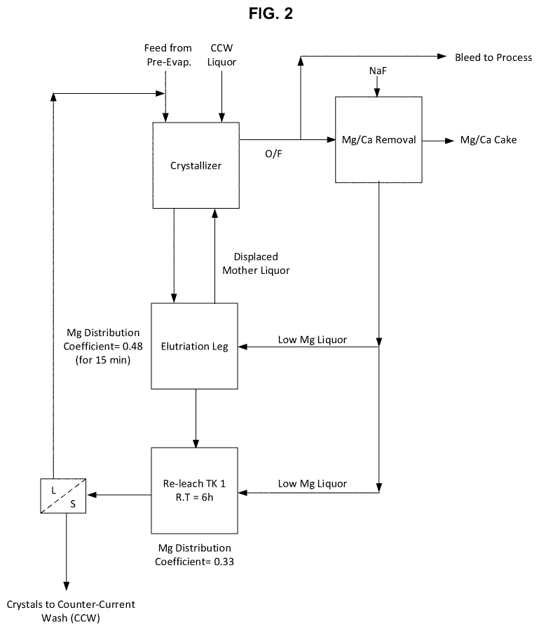

FIG. 2 shows an example of a process for removing magnesium and calcium impurities from cobalt sulfate heptahydrate (CoSO₄.7H₂O) crystals. Similarly to the process of FIG. 1, FIG. 2 shows a feed being fed to a crystallizer, to provide cobalt sulfate heptahydrate crystals and an overflow liquor send to Mg/Ca removal via precipitation induced by the addition of sodium fluoride. The crystallized cobalt sulfate of FIG. 2 is then fed to an elutriation leg, where the filtrate from Mg/Ca removal is fed, displacing the mother liquor stream from the crystallizer and washing a portion of the Mg from the crystals. This filtrate is used as it has a low concentration of Mg, but a high concentration of Co. Therefore, by mixing this stream with the crystals, a portion of the Mg from the crystals is washed without significantly dissolving the CoSO₄.7H₂O crystals. The premise behind the impurities removal is that the relative concentrations of microcomponents in relation to CoSO₄.7H₂O in the mother solution and in the washed crystal define the homogeneous distribution coefficient. The homogeneous distribution coefficient is dependent upon time, and the nature of the impurity (e.g. Cd, Fe, Mg, Ni, Zn, Mn, Cu, or Ca). The same principle applies to re-leach tank 1 of FIG. 2, where the crystallized metal sulfate is fed after the elutriation leg. For re-leach tank 1, a residence time of 6 hours was selected, to achieve a lower Mg distribution coefficient, allowing more Mg to be washed from the crystals. Any suitable residence time may be selected, for example, the residence time may be about 30 minutes to about 10 hours. The slurry from re-leach tank 1 is then dewatered. The liquor, concentrated with CoSO₄, is recycled to the feed of the crystallizer. The dewatered crystals are sent to the counter-current wash (CCW) circuit for Mg to be further washed.

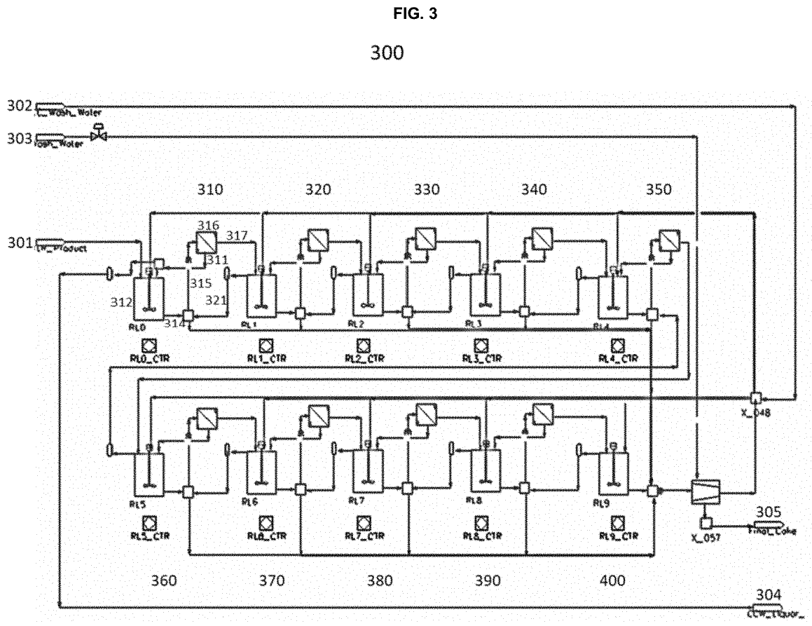

FIG. 3 shows an embodiment of a counter-current wash (CCVV) circuit/apparatus 300 for removing impurities from a crystallized metal sulfate 301, such as the cobalt sulfate heptahydrate crystals of FIG. 2. A counter-current wash circuit/apparatus 300 may consist of multiple stages of washing to achieve a target impurity (e.g. Mg) concentration. A counter-current wash circuit/apparatus 300 may include one or more inputs for wash water, such as counter-current wash water 302 and wash water 303. In each stage 310, 320, 330, 340, 350, 360, 370, 380, 390, 400, wash liquor and the solids are mixed in a tank with a select residence time, such as 6 hours (to achieve the optimal distribution coefficient of Mg). For example, in the first stage 310, wash liquor 311 is mixed with the solids 301 in a tank 312. The overflow from each stage is combined with the discharge slurry of the previous stage and the combined stream is sent to a screen for dewatering. For example, the overflow 321 from the second stage 320 is combined with the discharge slurry 314 of the first stage 310 and the combined stream 315 is sent to the screen 316 for dewatering. The dewatered solids are advanced to the next stage and the liquor is sent to previous stage (i.e. the solid and aqueous streams flow counter-currently in this circuit). For example, in the first stage 310, the dewatered solids 317 are advanced to the second stage 320 and the liquor 311 is sent to the previous stage 310. Wash water 303 is used in the last stage 400 of this circuit, which provides a final cake 305 of purified crystallized metal sulfate. The wash liquor 304 from the first stage 310, which is concentrated with CoSO₄, is sent to the crystallizer. For the CCW circuit 300 of FIG. 3, the final concentration of Mg in the wash liquor 304 is based on the distribution coefficient and the final concentration of Co is based on the solubility limit of CoSO₄. The counter-current flow allows for a more efficient mass transfer between the crystals and the washing liquor (in comparison with co-current flows). The number of stages or the flow of wash water can be adjusted accordingly to achieve a higher/lower concentration of Mg in the final crystals. Approximately every two stages remove about 50% of Mg from the crystals in the embodiment of FIG. 3.

In a CCW circuit, such as that of FIG. 3, washing liquor from the first tank may be recycled to a metal sulfate crystallizer. The washing liquor to be recycled may be subject to one or more further processing steps, such as concentration or other enrichment. The washing liquor for the last washing tank in the sequence is preferentially substantially free of impurities, and may be water or a substantially pure metal sulfate brine. The solid/liquid separation apparatus employed in the CCW circuit may be any suitable means of separating solid from liquid, such as a centrifuge, a thickener, or a screen.

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

As used herein, an ‘impurity’ refers to a component of a feedstock that is not a metal sulfate as described herein, or does not contribute to formation of a metal sulfate or crystallized metal sulfate as described herein. As used herein, an ‘impurity’, once isolated from a feedstock, may be a useful, valuable, or desirable material. In one or more embodiments, the impurity may be a sulfate other than a target sulfate. For example, a process may produce two or more sulfates, such as magnesium sulfate, cobalt sulfate, and/or nickel sulfate. Any one of those sulfates may be considered an impurity in the production of any of the sulfates.

As used herein, “crystallization”, “crystallizing”, or “crystallized” refers to the process of forming a crystal network that selectively and slowly formed from metal sulfates in an aqueous solution, such as a leached solution (or PLS), resulting in a more purified crystalline compound. In contrast, as used herein, “precipitation” refers to a process characterized by the addition of a precipitation or basification reagent and the formation of a crystalline or amorphous solid from solution. As used herein, “co-crystallize” or “co-crystallizing” refers to crystallizing two or more components (e.g., metal sulfates, impurities, etc.) out of solution together (e.g., at the same time). Used herein, when referencing “selectively crystallizing” or “selectively co-crystallizing” metal sulfates, “selective” refers to crystallizing the metal sulfate away from most, if not all impurities or other components; in other words, “selective” refers to forming a more pure, crystallized metal sulfate.

As used herein, “feedstock” or “pre-leached feedstock” refers to solid matter that comprises at least some materials that are desirable to extract/isolate from said solid(s) for further processing and/or use in end products, such as metals desirable in the production of materials for batteries.

As used herein, a ‘treatment process’ refers a process that may comprise a pre-treatment step (e.g., pre-leaching), a refining step that treats a leached solution to remove impurities (e.g., fluoride precipitation, direct lithium extraction), or a combination of both.

As used herein, “NMC” refers to nickel, manganese, and/or cobalt. For example, NMC sulfates refers to nickel sulfate, manganese sulfate, and/or cobalt sulfate. As used herein, “metal sulfates” refers to any one or combination of nickel sulfate, cobalt sulfate, and/or manganese sulfate. Further, “metal hydroxides” refers to any one or combination of nickel hydroxide, cobalt hydroxide, and/or manganese hydroxide. The term “metal hydroxides” as used herein may also refer to any one or combination of sodium hydroxide, potassium hydroxide, and/or lithium hydroxide.

Processes for Generating Metal Sulfate

In one aspect, there is provided a process for generating a metal sulfate, the process comprising: crystallizing a metal sulfate from an aqueous solution to form a crystallized metal sulfate in a mother liquor, the mother liquor comprising an uncrystallized metal sulfate. The process may further comprise separating the crystallized metal sulfate from the mother liquor. The crystallized metal sulfate generated in such a process may be further purified using a process for removing impurities from a crystallized metal sulfate according to one or more embodiments of the present disclosure.

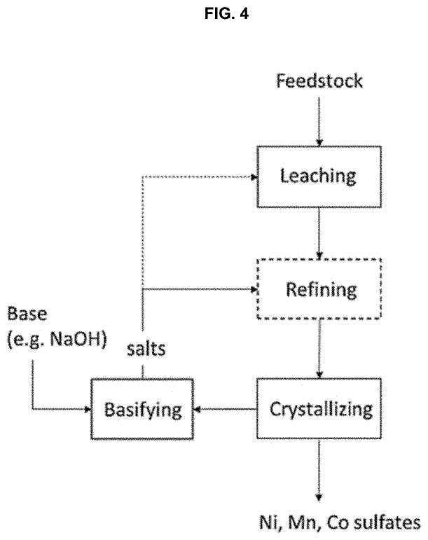

FIG. 4 shows a flow diagram of a general process for generating crystallized metal sulfates, which may include basifying a portion of the mother liquor, such as with a metal hydroxide, to convert the uncrystallized metal sulfate to a basic metal salt. The basic metal salt may be used upstream of crystallizing the metal sulfate. The crystallizing step may include one or more processes for removing impurities from a crystallized metal sulfate according to the present disclosure. The crystallizing may further comprise bleeding the mother liquor and controlling the bleed rate to selectively inhibit crystallizing an impurity when crystallizing the metal sulfate. The crystallizing may further comprise controlling an amount of free water in the crystallizer to selectively inhibit crystallizing an impurity when crystallizing the metal sulfate. Controlling the amount of free water may comprise controlling the rate of water evaporation from the crystallizer or controlling the addition of water to the crystallizer. Basifying the portion of the mother liquor to convert the uncrystallized metal sulfate to the basic metal salt may further comprise: bleeding the mother liquor and controlling the bleed rate to produce an amount of the basic metal salt that is at least approximately equivalent to an amount of the acid to be neutralized upstream of crystallizing the metal sulfate. The crystallized metal sulfate may be battery-grade crystallized metal sulfate.

In one or more embodiments of the process for generating metal sulfate described herein, the process further comprises leaching a feedstock and forming the aqueous solution comprising the metal sulfate. In one or more embodiments, the feedstock comprises any one or combination of mixed hydroxide precipitates, mixed sulfide precipitates, nickel sulfide concentrate, cobalt sulfide concentrate, nickel laterite, nickel matte, ferronickel, material derived from recycled lithium ion batteries or lithium ion battery manufacturing scrap, or spent cathode material. In one or more embodiments, the feedstock comprises previously produced and/or previously crystallized metal sulfate(s). That feedstock may comprise a metal sulfate comprising impurities, such as previously produced nickel sulfate or cobalt sulfate crystals. That feedstock may comprise a solution comprising metal sulfate. The process of generating metal sulfate may comprise the step of solubilizing the metal sulfate in the feedstock prior to further processing that feedstock. In an embodiment, a crystalized metal sulfate is produced at a first location, conveyed to a second location and dissolved into a solution which is used to help remove impurities from a crystalized metal sulfate at the second location. The solution may then be re-crystalized at the second location to recover the metal sulfate. In one or more embodiments of the process described herein, the process further comprises isolating the basic metal salt from the mother liquor. In one or more embodiments, isolating the basic metal salt comprises using a one-stage or two-stage precipitation circuit and selectively precipitating the basic metal salt. In one or more embodiments of the process described herein, the metal sulfate is any one or combination of nickel sulfate, cobalt sulfate, or manganese sulfate. In one or more embodiments of the process described herein, the basic metal salt comprises a metal hydroxide. In one or more embodiments, the metal hydroxide comprises any one or a combination of nickel hydroxide, cobalt hydroxide, or manganese hydroxide.

In one or more embodiments of the process for generating metal sulfate described herein, crystallizing the metal sulfate comprises selectively crystallizing any one or two of the nickel sulfate, manganese sulfate, and cobalt sulfate from the aqueous solution. In one or more embodiments of the process described herein, crystallizing the metal sulfate comprises selectively crystallizing any combination of the nickel sulfate, manganese sulfate, and cobalt sulfate from the aqueous solution. In one or more embodiments of the process described herein, the crystallized metal sulfate is a battery-grade crystallized metal sulfate, or an electroplating-grade crystallized metal sulfate.

In one or more embodiments, the process for generating metal sulfate as described herein further comprises refining the aqueous solution comprising the metal sulfate (e.g., a sulfate-matrix, pregnant leach solution (PLS), where the PLS is subjected to any one or combination of refining stages (also referred to herein as impurity or component removal stages) to remove specific impurities or components such as: Cu (e.g., via sulfiding, solvent extraction, cementation, ion exchange, etc.), Fe and Al (e.g., via precipitation, ion exchange, etc.), Zn (e.g., via sulfiding, solvent extraction, ion exchange, etc.), Co (e.g. via solvent extraction, ion exchange, precipitation etc.), Ca (e.g. via solvent extraction, ion exchange, etc.), Mg (e.g. via solvent extraction, ion exchange etc.), F (e.g. via calcium/lime addition), or graphite (e.g. via filtration). The refined PLS may be introduced into a crystallizer under conditions sufficient to selectively crystalize any one or combination of nickel sulfate (NiSO₄), cobalt sulfate (CoSO₄), manganese sulfate (MnSO₄), and lithium sulfate (Li₂SO₄) from the refined PLS to produce crystallized metal sulfates in a mother liquor (e.g., via a forced circulation crystallizer under vacuum, etc., against lithium, magnesium, sodium, or potassium depending on the feedstock). These crystallized metal sulfates are then isolated from the mother liquor (e.g., discharged from the crystallizer). If one crystallization cycle (e.g., using one crystallizer) is insufficient to produce crystallized metal sulfates (which may occur, e.g., with feedstocks containing higher concentrations of impurities), the crystals discharged from the crystallizer may be dissolved in pure water to form aqueous sulfate solutions before being introduced into a second crystallization cycle (e.g., using a second crystallizer) to be recrystallized.

After crystallization, the mother liquor may contain impurities, including undesired salts/metals (e.g., Li₂SO₄, MgSO₄, Na₂SO₄ etc.), as well as metal sulfates that did not crystallize out of solution (also referred to herein as the uncrystallized metal sulfate). In an embodiment, to selectively recover these uncrystallised metal sulfates from the remaining undesired materials in solution, the mother liquor may be bled from the crystallizer(s), and basified to convert the uncrystallised metal sulfates into basic metal salts, such as metal hydroxides (e.g., Ni(OH)₂, Co(OH)₂, Mn(OH)₂, etc.). These metal hydroxides may be used up-stream to neutralize acids introduced during the leaching that formed the PLS and/or the refining stages of the process, thus converting the metal hydroxides back to metal sulfates that can then be isolated via crystallization. Prior to use upstream, the metal hydroxides may be isolated from the mother liquor and washed, and may be reslurried with water for transfer, which can limit exposure to air and thus limit oxidation of the hydroxides. In an alternate embodiment, after crystallization, some or all of the mother liquor (overflow solution) may be used to help remove impurities from the crystalized metal sulfates. In that embodiment, the overflow solution is first processed to remove at least a portion of the impurities to provide a liquor rich in metal sulfate and low in impurities. The crystalized metal sulfate is then contacted with that liquor to help displace at least a portion of the impurities from the crystals. The liquor that remains after this step may have an even higher amount of impurities. That liquor may be basified to convert any remaining uncrystalized metal sulfates into basic metal salts. The basic metal salts may be used up stream as disclosed herein. In addition to using the metal hydroxides as neutralizing agents, the process may also use external sources of neutralizing agents (e.g., added oxides, hydroxides) to basify the mother liquor coming out of the crystallizer, and optionally to neutralize acids introduced during leaching and/or the refining stages. These external neutralizing agents are selected either for their capacity to be regenerated from their waste product (e.g., via electrolysis, etc.), to minimize or avoid forming waste streams (e.g., CaO/CaCO₃ as agents, CaSO₄.2H₂O as waste product; NaOH as agent, Na₂SO₄ as waste product); or for their capacity to generate higher valued by-products (e.g., KOH as agent, K₂SO₄ as by-product). In one or more embodiments, NaOH is used as a neutralizing agent and a sodium sulfate stream is formed in the basifying step.

Generally, the process of generating a metal sulfate is largely feedstock-agnostic, and can tolerate raw feedstocks (e.g., concentrates, mixed hydroxide/sulfide precipitates, other Ni-based feedstocks) and recycled feedstocks (e.g., spent battery materials). The process may also include leaching feedstocks under conditions (e.g. pressure leaching, pressure oxidation) to form the aqueous solution comprising the metal sulfate (e.g., the sulfate-matrix, pregnant leach solution (PLS). The process may produce any one or combination of crystalized nickel sulfate (NiSO₄), cobalt sulfate (CoSO₄), manganese sulfate (MnSO₄), and lithium sulfate (Li₂SO₄). The process may produce any one or two of crystalized nickel sulfate (NiSO₄), cobalt sulfate (Co—SO₄), and manganese sulfate (MnSO₄). The process may produce all three of crystalized nickel sulfate (NiSO₄), cobalt sulfate (CoSO₄), and manganese sulfate (MnSO₄). Of the crystallized metal sulfates isolated from the process, some may be battery-grade. Of the crystallized metal sulfates isolated from the process, some may be suitable for use in electroplating. Of the crystallized metal sulfates isolated from the process, some may be metal sulfate hydrates (e.g., crystallized metal sulfates and water molecules combined in a variety of ratios as an integral part of the crystal; for example, a ratio of one water molecule per metal sulfate, or six water molecules per metal sulfate, or seven water molecules per metal sulfate).

In one or more embodiments of the process described herein, the process comprises leaching a feedstock and forming the aqueous solution comprising the metal sulfate. For example, the process may begin with an input of one or more feedstocks. Suitable feedstocks include any feedstock that comprises any one or a combination of nickel (Ni), cobalt (Co), manganese (Mn), or lithium (Li). In some embodiments, the feedstock may comprise any one or combination of a raw feedstock, and a recycled materials feedstock. Examples of raw feedstocks include, but are not limited to, mixed hydroxide precipitates (MHP), mixed sulfide precipitates (MSP), nickel sulfide concentrate, cobalt sulphide concentrate, nickel laterite, nickel matte, or ferronickel. Examples of recycled materials feedstocks include, but are not limited to, spent cathode material, and material derived from recycled lithium ion batteries or lithium ion battery manufacturing scrap (collectively, referred to herein as black mass).

The feedstock may be leached under conditions to form an aqueous solution comprising a metal sulfate (PLS); for example, a sulfate-matrix, pregnant leach solution. Generally, leaching conditions comprise reacting the feedstock with an acidic leachate stream that may comprise: an acid stream; an acid stream and hydrogen peroxide; an acid stream and sulphur dioxide; or an acid stream and another reductant, such as sucrose. The leaching conditions may also comprise solubilizing the feedstock by oxidizing it in a pressure vessel using oxygen or air. In forming the sulfate-matrix PLS, the acid stream may act as a sulfate source, and comprise, e.g., sulfuric acid; or the acid stream and/or the feedstock may act as a sulfate source.

There are a number of leaching conditions that may be suitable for forming the PLS. Based on the type or source of feedstock to be processed, a skilled person would recognize which leaching conditions to select and test, in order to confirm the selection and to define the specific conditions. For example, leaching may occur at ambient, or above ambient temperatures and/or pressures. For feedstocks comprising MHP or black mass, leaching may occur at temperatures of about 65° C. and at atmospheric pressures, e.g., with the addition of acid and reducing agents. For feedstocks comprising MSP or nickel matte, leaching may occur via pressure leaching and/or pressure oxidation at temperatures between 150 and 220° C.

The leaching conditions may be selected to minimize use of acid or base reagents. For example, the leaching conditions may comprise countercurrent leaching, which involves contacting and flowing the feedstock and acidic leachate stream in opposing directions. Using such a countercurrent flow can increase leaching efficiencies and decrease acid reagent use at the leaching stage. By reducing acid reagent use, countercurrent leaching can also reduce base reagent use, as there would be less acid passing downstream in the process that would need to be later neutralized by a base. In some embodiments, the leaching conditions may comprise pressure leaching, which by oxidation of sulfides in the feedstock, may generate sulfates and thus not require additional acid reagent to be used to solubilize metals in the feedstock.

In one or more embodiments, the process for generating metal sulfate as described herein comprises refining the aqueous solution comprising the metal sulfate (e.g., a sulfate-matrix, pregnant leach solution (PLS), where the PLS is subjected to any one or combination of refining stages (also referred to herein as impurity or component removal stages) to remove specific impurities or components.

Following leaching, the PLS may undergo one or more refining stages to refine the PLS by removing one or more impurities or components. The type and amount of impurities or components to be removed is dependent, at least in part, on the type of feedstock from which the PLS is formed, as well as the specifications for the final product generated by the process (e.g., purity, grade, when only one or two of nickel sulfate (NiSO₄), cobalt sulfate (Co—SO₄), and manganese sulfate (MnSO₄) are required, etc.). Examples of impurities or components to be removed include, but are not limited to, sodium (Na), aluminum (Al), iron (Fe), copper (Cu), zinc (Zn), lithium (Li), cobalt (Co), and manganese (Mn). Components that may need to be removed may include any one or two of nickel, cobalt, and manganese, such that only one or two of crystallized nickel sulfate (NiSO₄), cobalt sulfate (CoSO₄), and manganese sulfate (MnSO₄) are isolated from the crystallizer; e.g., for use as a final product, such as battery-grade metal sulfate(s). Otherwise, all three of nickel sulfate (NiSO₄), cobalt sulfate (CoSO₄), and manganese sulfate (MnSO₄) are isolated from the crystallizer. When battery-grade metal sulfates are required, there are specific product specifications (e.g., limits) for such impurities that are tolerated for, e.g., battery-grade nickel sulfate; and any such impurities that are present in a process' feedstock, water, or reagents in an amount that exceeds said product specification would need to have their concentration reduced.

There are many suitable methods for removing impurities or components from the PLS. Such methods include, but are not limited to precipitation, atmospheric or pressure leaching, sulfidation, solvent extraction, ion exchange, and cementation. Selecting the appropriate method (and operational conditions thereof) depends, at least in part, on the type and amount of impurities or components to be removed, as well as the specifications for the final product generated by the process. For example, copper may be removed via precipitation, solvent extraction, sulfidation, cementation, or ion exchange, etc.; iron and aluminum may be removed via precipitation, or ion exchange, etc.; zinc may be removed via sulfidation, solvent extraction, or ion exchange, etc.; and cobalt may be removed via solvent extraction, ion exchange, or oxidative precipitation etc. The conditions and operational parameters for each method are generally known and can be selected depending on the type and amount of impurity or component to be removed.

For example, cementation is a process involving a redox reaction between a first metal ion and a first solid metal, whereby the first metal ion is reduced to a second solid metal by the first, and the first solid metal is in turn oxidized to a second metal ion. Cementation may be selected for removing, e.g., copper because it can add value metals to the process (for example, by adding Ni if nickel powder is used as the first solid metal) without the use of other reagents; and/or because it can allow removal of impurities (for example, by reduction) without having to add acid or base reagents to the process.

The refining stages for removing impurities or components from the PLS may be selected to minimize use of acid or base reagents. For example, Cu can be removed via cementation with nickel powder, which requires little acid and no base, and generates no acid; in contrast, removal of Cu by solvent extraction (SX) requires one mole of sulphuric acid per mole of Cu removed, and all of said added acid needs to be neutralized by a base downstream. Other impurities such as Fe and Al can be removed via precipitation by raising the pH (e.g., to about 5.5), which requires added base but no added acid; base which can be introduced as an external neutralizing agent, or as a basic metal salt generated downstream in the process. In contrast, removal of Fe and Al by ion exchange (IX) requires added base to load the Fe and Al onto the exchange column, and it also requires added acid to strip the Fe and Al off the exchange column, and additional reagents or process steps to convert those impurities to a disposable form.

The process described herein may comprise crystallizing a metal sulfate from an aqueous solution to form a crystallized metal sulfate. The refined PLS may be introduced into a crystallizer under conditions sufficient to selectively crystalize or co-crystallize any one or combination of nickel sulfate, cobalt sulfate, manganese sulfate, and/or lithium sulfate from solution. Such selective crystallization occurs against components such as lithium, sodium, potassium, magnesium, that remain in the refined PLS (depending on the feedstock) to provide one or more crystallized metal sulfates (e.g., NMC sulfates and/or lithium sulfates) in a mother liquor.

Different types of crystallizers may be suitable for affecting the selective crystallization or co-crystallization of NMC sulfates and/or lithium sulfates. Such crystallizers include, but are not limited to, evaporative crystallizers, forced circulation (FC) crystallizers, indirect force circulation (IFC) crystallizers, and draft tube baffle (DTB) crystallizers. The conditions and operational parameters for such crystallizers can be selected depending on the type and purity of metal sulfate to be crystallized, and/or the type and concentration of impurities in the PLS. For example, if an IFC or DTB crystallizer is used, coarser crystals may be formed when crystallizing NMC sulfates; this can inhibit the entrainment of impurities during said crystallization, such as lithium, sodium magnesium, and/or potassium. If a forced circulation crystallizer is used, it may be operated under vacuum in order to flash cool the PLS to ambient temperatures (e.g., about 25° C.), which in turn can facilitate water evaporation and NMC sulfate and/or lithium sulfate crystallization. In such cases, the amount of free water being evaporated may be less than the amount necessary to reach a saturation point of certain impurities, such as lithium or sodium. When a crystallizer is used to selectively crystallize nickel sulfate, cobalt sulfate, and manganese sulfate together against impurities such as lithium and sodium, the crystallizer may be operated at a pH level between 1-5, or between 1.5-2.5. In some embodiments, a pH level less than 0, less than 1.5, or between 0.5-1.5 is effective.

Further, the conditions and operational parameters of the crystallizer may be selected to selectively crystallize one metal sulfate, or combination of metal sulfates, over other sulfates and components (e.g., impurities) in solution. For example, when the concentration of one or two metal sulfates are at a very low concentration in the PLS, and a third metal sulfate is at a much higher concentration, careful selection of the crystallizer bleed rate (e.g., a sufficiently high bleed rate) can allow for selective crystallization of the third metal sulfate over the one or two metal sulfates.

The conditions and operational parameters for the crystallizer may also be selected to manage the purity of the crystallized metal sulfates. Bleeding the mother liquor from the crystallizer during crystallization, and the rates at which the bleeding occurs, can impact the purity of the crystallized metal sulfates; for example, by selectively inhibiting crystallization of impurities. As used herein, selecting a bleed rate to selectively inhibit crystallization of a specific impurity means to set a crystallizer bleed rate, within a range of possible bleed rates that inhibits the crystallization of the specific impurity more so than it would inhibit crystallization of a different impurity. The bleed rate may be selected such that it maximizes inhibiting crystallization of the specific impurity. The impurities may be sodium, potassium, magnesium, etc. Using a higher bleed rate of the mother liquor helps to maintain lower concentrations of impurities and other components in the mother liquor that could impact the purity of the crystallized metal sulfates.

Further, impurity solubility can be temperature dependent; therefore, selecting the crystallizer temperatures can be effective in managing the purity of the metal sulfate(s) being crystallized. For example, lithium sulfate solubility decreases with increasing temperature, so if the crystallizer is operated at higher temperatures, any lithium sulfate remaining in the PLS may precipitate out and impact the purity of the crystallized metal sulfates. However, if the crystallizer is operated at lower temperatures, the lithium sulfate may remain in solution and prevent it from coming out of solution with the crystallizing metal sulfate(s). Alternatively, if the crystallizer is operated under different temperature conditions while maintaining the same bleed rate, different levels of impurity contaminations may be obtained. In contrast, the solubility of sodium increases with increasing temperatures. As such, if the crystallizer is operated at higher temperatures, the sodium may remain in solution; and increasing the crystallizer bleed rate may remove the sodium from the crystallizer before it can come out of solution with the crystallizing metal sulfates. However, if the crystallizer is operated at lower temperatures, the sodium remaining in the mother liquor may precipitate, due to its lower solubility, or may react with nickel to form double salts that can impact the purity of the crystallized metal sulfates.

Impurity solubility can also be dependent on the amount of free water present in the PLS and/or mother liquor; therefore, managing water levels in the crystallizer can be an effective means of managing the purity of the metal sulfate(s) being crystallized. For example, in some instances, the metal sulfates crystallize out of solution as metal-sulfate hydrates (i.e., crystallized metal sulfates and water molecules combined in a definite ratio as an integral part of the crystal), which reduces the concentration of water in the mother liquor. By decreasing the concentration of free water, the concentration of impurities (e.g. lithium, sodium, potassium, magnesium, etc.) in the mother liquor may also increase to the point that they crystallize out of solution and impact the purity of the crystallized metal sulfates. However, if a sufficient amount of water is added to the PLS and/or mother liquor when in the crystallizer, or if that amount of excess water remains in the PLS after upstream treatment (e.g., at least as much water as is expected to be lost due to hydrate formation), the presence of that free water can inhibit the crystallization of impurities out of solution.

The crystallized metal sulfates may be isolated from the mother liquor by discharging them from the crystallizer. For example, the crystallized metal sulfates may be discharged as a slurry that is passed to a filter or centrifuge to separate the crystals from the mother liquor. The filtrate or centrate (i.e., mother liquor) may then be passed back to the crystallizer, or a fraction of it may be bled; and the isolated crystals may be washed on the filter or centrifuge and dried. In some instances, using only one crystallizer is insufficient to produce suitably pure, crystallized metal sulfates, such as when the PLS is formed from dirtier feedstocks. Crystals discharged from a first crystallizer may then be dissolved in water (e.g., pure water) before being introduced into a second crystallizer to be recrystallized and further purified.

The process for generating metal sulfates described herein may comprise basifying a portion of the mother liquor to convert an uncrystallized metal sulfate to a basic metal salt. In one or more embodiments of the process described herein, the process comprises basifying the portion of the mother liquor using a second neutralizing agent to convert the uncrystallized metal sulfate to the basic metal salt. In one or more embodiments, converting the basic metal salt back to the uncrystallized metal sulfate comprises using the basic metal salt as a first neutralizing agent to neutralize acid upstream of crystallizing the metal sulfate.

The crystallization mother liquor may contain uncrystallised metal sulfates, in addition to other impurities and components, like salts and metals such as Li₂SO₄, Na₂SO₄, etc. To selectively recover these uncrystallised metal sulfates and to form basic metal salt(s) for use up-stream as neutralizing agents (also referred to herein as first neutralizing agents), the mother liquor may be bled from the crystallizer and basified in order to convert the uncrystallised metal sulphates remaining in the mother liquor to said basic metal salts, such as metal hydroxides (e.g., Ni(OH)₂, Co(OH)₂, Mn(OH)₂, etc.). When basifying the mother liquor, enough base may be added to increase the pH level to between 7.5-10, or between 7.5-9.5. The resultant metal hydroxides precipitate from the mother liquor, and may be isolated from the mother liquor via filtration and washed to form a cake, and may be re-pulped to form a slurry. For example, the metal hydroxides may be recovered by filtration, thickening and filtration, or centrifugation, and then washed on the filter or centrifuge to form the cake. At least a part of the cake may be passed to a re-pulp tank to be slurried using water or process solutions. The metal hydroxides may be selectively precipitated from the mother liquor; for example, via a one-stage or two-stage precipitation circuit. The precipitation circuits can be used to selectively precipitate the metal hydroxides from impurities in the metal hydroxides due to their presence in the mother liquor.

The metal hydroxides may be introduced up-stream in the process, and may be used as a neutralizing agent to neutralize acids introduced at the leaching and/or refining stages. For example, about 0% to 40% of the metal hydroxides (e.g., as a cake) may be introduced into the leaching stage; and about 60% to 100% of the metal hydroxides (e.g., as a cake) may be introduced into the refining stages. Using the metal hydroxides as a neutralizing agent reduces and/or eliminates the need to introduce external neutralizing agents; this reduces reagent use (and associated costs), and reduces and/or eliminates additional sources of impurities that may impact product purity (e.g., cations Na⁺, K⁺, Ca²⁺, Mg²⁺ from the external neutralizing agent), and would otherwise require the crystallizer bleed rate to be higher to avoid co-precipitation of the impurities and contamination of the crystallized metal sulfates. In some instances, to ensure that there is a sufficient amount of basic metal salts, e.g., metal hydroxides, available for use as a neutralizing agent, the rate at which the mother liquor is bled from the crystallizer and basified to form the metal hydroxides may be controlled such that the amount of metal hydroxides formed is at least approximately equivalent to, or approximately equivalent to the amount of acid introduced at the leaching and/or refining stages. For example, if the refined PLS is of high purity, the crystallizer bleed rate may not need to be very high to manage the purity of the crystallized metal sulfates (e.g., as described above); however, the crystallizer bleed rate may nonetheless need to be increased to ensure a sufficient amount of metal hydroxides are formed for use upstream. In other instances, the rate at which the mother liquor is bled from the crystallizer and basified to form the metal hydroxides may be controlled such that the amount of metal hydroxides formed in combination with an added amount of external neutralizing agent is at least approximately equivalent to, or approximately equivalent to the amount of acid introduced at the leaching and/or refining stages; however, the amount of external neutralizing agent added would be kept sufficiently low such that use of the external neutralizing agent didn't introduce impurities (e.g., cations Na₊, K₊, Li₊, Mg₂₊, etc.) at a concentration that would impact the purity of the crystallized metal sulfates. In such instances, a combination of the formed metal hydroxides and external neutralizing agent may be used to manage capital and/or operating costs. Further, the rate at which the metal hydroxides are metered to an upstream process may be controlled by a pH setpoint for said process (e.g., leaching, refining, etc.).

Further, using the basic metal salts (e.g., metal hydroxides) as a neutralizing agent converts the basic metal salts back to metal sulfates within the refined PLS. The refined PLS, comprising the converted metal sulfates, then proceeds on to the crystallizer, wherein the converted metal sulfates may be crystallized and isolated from the mother liquor. This loop of isolating and basifying the mother liquor to convert uncrystallised metal sulfates in solution to basic metal salts, and using those basic metal salts as neutralizing agents to convert the basic metal salts back to metal sulfates that can then be isolated via crystallization, can improve the yield of isolated, crystallized metal sulfates obtained from a particular feedstock.

In addition to using the basic metal salts, e.g., metal hydroxides, as a neutralizing agent, the process may use external sources of neutralizing agents (e.g., added oxides, hydroxides, etc.) in the refining stages to neutralize acids, and/or to basify the mother liquor bleed coming out of the crystallizer (also referred to herein as second neutralizing agents). Selecting the type(s) and amount(s) of external neutralizing agent may depend, at least in part, on the nature of the refining stages, and the type of metal sulfate and other components in the mother liquor. As a skilled person would recognize, there are different types of external neutralizing agents that would be suitable for use in the refining stages, and/or for use in basifying the mother liquor. Suitable external neutralizing agents include, but are not limited to, potassium hydroxide (KOH), calcium hydroxide (Ca(OH)₂), sodium hydroxide (NaOH), lithium hydroxide (LiOH), or magnesium oxide (MgO). For example, any one or combination of potassium hydroxide (KOH), calcium hydroxide (Ca(OH)₂), sodium hydroxide (NaOH), lithium hydroxide (LiOH), and magnesium oxide (MgO) may be used as an external neutralizing agent. A skilled person would also recognize that there are types of external neutralizing agents that would be less suitable for use in the refining stages and/or for use in basifying the mother liquor. For example, use of ammonia as an external neutralizing agent may result in the formation of double salts, such as nickel-ammonium sulfate salts, or metal complexes, such as or Ni and/or Co complexes. Such cations, salts or complexes can make processes non-feasible, and/or increase operational and capital costs due to requisite solvent extraction circuits.

The amount of external neutralizing agent may be selected depending on the nature of the refining stages. For example, if there is a high concentration of Cu that needs to be removed in a refining stage, then a high concentration/volume of neutralizing agent may be needed to neutralize any acid generated in a copper solvent extraction stage. Further, if there is a high concentration of Fe that needs to be removed in a refining stage, then a high concentration/volume of neutralizing agent will be needed to increase the pH and remove the Fe by hydrolysis.

The type of external neutralizing agent may be selected to generate and recover, via a salt recovery step, a particular by-product, such as a by-product that has commercial value. For example, if the external neutralizing agent is selected to be potassium hydroxide, then its use would generate potassium sulfate (K₂SO₄), a fertilizer. If the external neutralizing agent is selected to be calcium hydroxide, then its use would generate gypsum (CaSO₄.2H₂O), a product that may be disposed of as waste, or used in dry-wall and construction. If the external neutralizing agent is selected to be magnesium oxide (MgO), then its use would generate magnesium sulfate. If the external neutralizing agent is selected to be lithium hydroxide (LiOH), then its use would generate lithium sulfate.

The type of external neutralizing agent may also be selected based on its ability to be recovered, via a salt recovery step, and regenerated, so that the neutralizing agent can be used in the process, and then regenerated for re-use. For example, if the external neutralizing agent is selected to be sodium hydroxide, then its use would generate sodium sulfate as a by-product. Sodium hydroxide can be regenerated from sodium sulfate via electrolysis. In general, electrolysis can directly convert the by-product sodium sulfate back to sodium hydroxide for re-use in the process, producing sulfuric acid during the conversion. More particularly, electrolysis uses an applied electric potential and one or more ion selective membrane(s) to regenerate an acid and a base from a salt solution, and is conducted using an electrochemical cell that can comprise two or more compartments separated with selective membrane(s). For example, the electrolysis may involve a 3-compartment cell operating under 6V of potential with a current density between 1500-3000 A/m₂, which would be able to produce an approximately 20 wt % solution of sodium hydroxide along with an approximately 10 wt % solution of sulfuric acid from sodium sulfate, both of which can be recycled for use upstream in the process. If the external neutralizing agent is selected to be LiOH, then its use would generate lithium sulfate that could be converted back to LiOH using a downstream recovery step such as basification and crystallisation, or electrolysis, or could be converted to lithium carbonate as a saleable product. In one or more embodiments, the external neutralizing agent is sodium hydroxide, and its use generates sodium sulfate as a by-product.

In one or more embodiments of the present disclosure, the process for generating metal sulfates described herein provides the selective crystallization or co-crystallization of any one or combination of nickel sulfate (NiSO₄), cobalt sulfate (CoSO₄), manganese sulfate (MnSO₄), and lithium sulfate (Li₂SO₄). In one or more embodiments, the process described herein provides the selective crystallization or co-crystallization of one or two of crystalized nickel sulfate (NiSO₄), cobalt sulfate (CoSO₄), and manganese sulfate (MnSO₄). In one or more embodiments, the process described herein provides the selective co-crystallization of all three of crystalized nickel sulfate (NiSO₄), cobalt sulfate (CoSO₄), and manganese sulfate (MnSO₄). In one or more embodiments, the process described herein provides battery-grade, crystallized metal sulfates. In one or more embodiments, the process provides electroplating-grade, crystallized metal sulfates. In one or more embodiments, the process described herein does not use solvent extraction circuits to isolate battery-grade, crystallized metal sulfates. In one or more embodiments, the process described herein reduces capital and operating costs; increases yield of crystallized metal sulfates; and/or reduces or eliminates sodium sulfate as a solid waste (when sodium hydroxide is used as an external neutralizing agent, and the sodium sulfate is converted back to sodium hydroxide via electrolysis, or where the amount of external neutralising agent required is reduced).

In some embodiments, the process described herein reduces capital and operating costs because it uses a crystallizer to isolate crystallized metal sulfates, in place of solvent extraction circuits. While crystallization requires energy input, it does not require use of added reagents, thereby reducing operating costs. Further, the capital costs associated with crystallization are lower than those associated with solvent extraction circuits.

In other embodiments, the process described herein reduces capital and operating costs by reducing reagent use. For example, a nickel solvent extraction circuit to form nickel sulfate requires the consumption of 1 mole of sulfuric acid and 2 moles of sodium hydroxide per mole of nickel sulfate produced. In contrast, crystallization does not require the use of any added reagents. The process described herein can reduce reagent use even if a solvent extraction step is used as part of the refining stage, as said solvent extraction will generally experience a smaller load (i.e., impurities at lower concentrations), and so will require less acid and base. In some embodiments, the process described herein reduces capital and operating costs by reducing the number of processing steps. Reducing the number of process steps not only reduces capital and operating costs, it also reduces the complexity of the process, and therefore reduces the complexity of the infrastructure and skillsets needed to conduct the process. For example, solvent extraction is a relatively complex unit operation requiring multiple stages of extraction, scrubbing, and stripping; and requiring systems for treatment of aqueous discharge streams, crud removal, organic vapor recovery, and fire protection. By using a crystallizer to isolate crystallized metal sulfates, in place of solvent extraction circuits, such process complexity (and associated costs) can be avoided.

In other embodiments, the process described herein increases yield of crystallized metal sulfates by reducing or preventing the addition of specific impurities or components in the leaching and/or refining stages of the process, such as lithium, sodium, potassium, or magnesium. For example, as the one-pass yield of crystallized metal sulfates increases in the crystallizer, the concentrations of impurities such as lithium, sodium, etc. in the mother liquor also increases. As a result, the crystallizer bleed rate must also increase to manage the purity of the crystallized metal sulfates (for example, by inhibiting or preventing the impurities from approaching their saturation concentrations in the mother liquor). However, increasing the crystallizer bleed rate may create inefficiency, as the bled uncrystallised metal sulfates will be basified and precipitated, consuming reagents. As such, reducing or preventing the addition of these impurities in the leaching and/or refining stages of the process means the crystallizer can be operated at a lower bleed rate while avoiding co-crystallization of impurities with the metal sulfates, which can improve the one-pass yield of crystallized metal sulfates while also decreasing operational costs. In one or more embodiments of the process of the present disclosure, the addition of specific impurities (e.g., lithium, sodium, magnesium, etc.) is reduced or prevented by using the basic metal salts (e.g., the metal hydroxides Ni(OH)₂, Co(OH)₂, Mn(OH)₂, etc.) precipitated from the mother liquor that is bled from the crystallizer. In some embodiments, precipitation and washing of the basic metal salts is carefully controlled (e.g., by selection of pH levels, use of two-stage precipitation circuits, etc.) to reduce or prevent precipitating impurities (e.g., lithium, sodium, magnesium, etc.) into the basic metal salts.

In some embodiments, the process described herein increases yield of crystallized metal sulfates by using a loop of isolating and basifying crystallization mother liquors to convert uncrystallised metal sulfates in solution to basic metal salts (e.g., metal hydroxides), and using those basic metal salts as neutralizing agents to convert the salts back to metal sulfates for crystallization. The iterative nature of the loop ensures a very good recovery of crystallized metal sulfates.

Crystallized metal sulfate, whether generated by a process for generating metal sulfate according to the present disclosure or otherwise, may be subjected to a process for removing impurities from a crystallized metal sulfate according to one or more embodiments or the present disclosure. Similarly, the counter-current wash circuit for removing impurities from crystallized metal sulfate according to the present disclosure may be used to remove impurities from any suitable source of crystallized metal sulfate, such as, but not limited to, the processes for generating metal sulfate herein disclosed.

### Example Embodiments

1. A process for removing impurities from a crystallized metal sulfate, the process comprising:
   contacting the crystallized metal sulfate with a liquor rich in metal sulfate.
2. The process of embodiment 1, wherein the metal sulfate is cobalt sulfate, nickel sulfate, or manganese sulfate.
3. The process of embodiment 1 or 2, wherein the crystallized metal sulfate is in the form of a crystal lattice and the impurities are distributed within the crystal lattice.
4. The process of any one of embodiments 1 to 3, wherein the impurities comprise trace metal cations with an oxidation state of +2.
5. The process of any one of embodiments 1 to 4, wherein the impurities comprise magnesium, calcium, sodium, or lithium.
6. The process of any one of embodiments 1 to 5, further comprising providing the liquor rich in metal sulfate which comprises a level of impurities lower than a level of impurities in the crystallized metal sulfate.
7. The process of any one of embodiments 1 to 6, wherein the liquor rich in metal sulfate comprises a similar concentration of metal sulfate as the metal sulfate concentration in a crystallization liquor from which the crystalized metal sulfate was crystallized.
8. The process of embodiments 1 to 7, further comprising forming the liquor rich in metal sulphate by mixing a portion of the metal sulphate crystals with water.
9. A process for crystallizing a select metal sulfate, the process comprising:
   crystallizing a metal sulfate from an aqueous solution to form crystals rich in the select metal sulfate and an overflow solution comprising metal sulfate and impurities; and
   contacting the crystals rich in the select metal sulfate with a liquor rich in metal sulfate thereby displacing at least a portion of the impurities from the crystals rich in the select metal sulfate.
10. The process of embodiment 9, further comprising removing at least a portion of the impurities from the overflow solution to provide the liquor rich in metal sulfate.
11. The process of embodiment 9 or 10, wherein crystallizing the metal sulfate-rich feed solution comprises preferentially crystallizing the select metal sulfate, relative to alternative metal sulfate salts, from the metal sulfate-rich feed solution.
12. The process of any one of embodiments 9 to 11, further comprising re-using the liquor elsewhere in the process or in a related process.
13. The process of embodiment 12, wherein re-using the liquor comprises adding at least a portion of the liquor to the metal sulfate aqueous solution for crystallizing.
14. The process of any one of embodiments 9 to 13, wherein removing at least a portion of the impurities from the overflow solution comprises precipitation or ion exchange.
15. The process of any one of embodiments 9 to 14, wherein contacting the crystals rich in metal sulfate comprises treating the crystals rich in metal sulfate in a counter-current wash circuit.
16. The process of any one of embodiments 9 to 15, wherein the select metal sulfate is cobalt sulfate, nickel sulfate, or manganese sulfate.
17. The process of any one of embodiments 9 to 16, wherein the crystals rich in metal sulfate define a crystal lattice and the impurities are distributed within the crystal lattice.
18. The process of any one of embodiments 9 to 17, wherein the impurities comprise trace metal cations with an oxidation state of +2.
19. The process of embodiment 18, wherein the impurities comprise magnesium, calcium, or sodium.
20. The process of any one of embodiments 9 to 19, wherein the liquor rich in metal sulfate comprises a level of impurities lower than a level of impurities in the crystals rich in metal sulfate.
21. The process of any one of embodiments 1 to 6, wherein the liquor rich in metal sulfate comprises a similar concentration of metal sulfate as the metal sulfate concentration in the metal sulfate-rich feed solution.
22. A counter-current wash circuit for removing impurities from crystallized metal sulfate, the counter-current wash circuit comprising:
   a plurality of washing tanks configured to receive crystallized metal sulfate in a sequence and a washing liquor in reverse of the select sequence, each washing tank coupled to a solid/liquid separation apparatus for separating the crystallized metal sulfate from the washing liquor, wherein the crystallized metal sulfate of a given washing tank is advanced to the next washing tank in the sequence and the washing liquor from said given washing tank is advanced to the previous washing tank in the sequence.
23. The counter-current wash circuit of embodiment 22, wherein each washing tank is configured to contact the crystallized metal sulfate and the washing liquor for a specified residence time.
24. The counter-current wash circuit of embodiment 23, wherein the residence time is about 6 hours.
25. The counter-current wash circuit of embodiment 23 or 24, wherein the washing liquor for the last washing tank in the sequence is substantially free of impurities.
26. The counter-current wash circuit of embodiment 25, wherein the washing liquor for the last washing tank in the sequence is water.
27. The counter-current wash circuit of any one of embodiments 23 to 26, wherein the washing liquor for the first washing tank in the sequence is to be recycled to a metal sulfate crystallizer.
28. The counter-current wash circuit of any one of embodiments 23 to 27, wherein the solid/liquid separation apparatus is a centrifuge, a thickener, or a screen.
29. The counter-current wash circuit of any one of embodiments 23 to 28, wherein the metal sulfate is cobalt sulfate, nickel sulfate, or manganese sulfate.
30. The counter-current wash circuit of any one of embodiments 23 to 29, wherein the crystallized metal sulfate defines a crystal lattice and the impurities are distributed within the crystal lattice.
31. The counter-current wash circuit of any one of embodiments 9 to 17, wherein the impurities comprise trace metal cations with an oxidation state of +2.
32. The counter-current wash circuit of embodiment 18, wherein the impurities comprise magnesium, calcium, or sodium.
33. The process of any one of embodiments 1 to 8 or 21, further comprising:
   crystallizing a metal sulfate from an aqueous solution to form the crystallized metal sulfate in a mother liquor, the mother liquor comprising an uncrystallized metal sulfate;
   separating the crystallized metal sulfate from the mother liquor;
   basifying a portion of the mother liquor to convert the uncrystallized metal sulfate to a basic metal salt; and
   using the basic metal salt upstream of crystallizing the metal sulfate.
34. The process of any one of embodiments 9 to 20, further comprising:
   basifying at least a portion of the overflow solution to convert uncrystallized metal sulfate to a basic metal salt; and
   using the basic metal salt upstream of crystallizing the metal sulfate.
35. A process for generating a metal sulfate, the process comprising:
   crystallizing a metal sulfate from an aqueous solution to form a crystallized metal sulfate in a mother liquor, the mother liquor comprising an uncrystallized metal sulfate;
   separating the crystallized metal sulfate from the mother liquor;
   contacting the crystallized metal sulfate with a liquor rich in metal sulfate to remove impurities from the crystallized metal sulfate;
   basifying a portion of the mother liquor to convert the uncrystallized metal sulfate to a basic metal salt; and
   using the basic metal salt upstream of crystallizing the metal sulfate.
36. The process of embodiment 35, further comprising:
   purifying the mother liquor to form the liquor rich in metal sulfate.
37. The process of embodiment 35 or 36, wherein contacting the crystallized metal sulfate with a liquor rich in metal sulfate thereby forms a liquor containing metal sulfate and impurities, and the process further comprises:
   basifying a portion of the liquor containing metal sulfate and impurities to convert the metal sulfate to a basic metal salt.

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A process for removing impurities from a crystallized metal sulfate, the process comprising:
contacting the crystallized metal sulfate with a liquor rich in metal sulfate.

2. The process of claim 1, wherein the metal sulfate is cobalt sulfate, nickel sulfate, or manganese sulfate.

3. The process of claim 1, wherein the crystallized metal sulfate is in the form of a crystal lattice and the impurities are distributed within the crystal lattice.

4. The process of claim 1, wherein the impurities comprise trace metal cations with an oxidation state of +2.

5. The process of claim 1, wherein the impurities comprise magnesium, calcium, sodium, or lithium.

6. The process of claim 1, further comprising providing the liquor rich in metal sulfate which comprises a level of impurities lower than a level of impurities in the crystallized metal sulfate.

7. The process of claim 1, wherein the liquor rich in metal sulfate comprises a similar concentration of metal sulfate as the metal sulfate concentration in a crystallization liquor from which the crystalized metal sulfate was crystallized.

8. The process of claim 1, further comprising forming the liquor rich in metal sulphate by mixing a portion of the metal sulphate crystals with water.

9. A process for crystallizing a select metal sulfate, the process comprising:
crystallizing a metal sulfate from an aqueous solution to form crystals rich in the select metal sulfate and an overflow solution comprising metal sulfate and impurities; and
contacting the crystals rich in the select metal sulfate with a liquor rich in metal sulfate thereby displacing at least a portion of the impurities from the crystals rich in the select metal sulfate.

10. The process of claim 9, further comprising removing at least a portion of the impurities from the overflow solution to provide the liquor rich in metal sulfate.

11. The process of claim 9, wherein crystallizing the metal sulfate-rich feed solution comprises preferentially crystallizing the select metal sulfate, relative to alternative metal sulfate salts, from the metal sulfate-rich feed solution.

12. The process of claim 9, further comprising re-using the liquor elsewhere in the process or in a related process.

13. The process of claim 12, wherein re-using the liquor comprises adding at least a portion of the liquor to the metal sulfate aqueous solution for crystallizing.

14. The process of claim 9, wherein removing at least a portion of the impurities from the overflow solution comprises precipitation or ion exchange.

15. The process of claim 9, wherein contacting the crystals rich in metal sulfate comprises treating the crystals rich in metal sulfate in a counter-current wash circuit.

16. The process of claim 9, wherein the select metal sulfate is cobalt sulfate, nickel sulfate, or manganese sulfate.

17. The process of claim 9, wherein the crystals rich in metal sulfate define a crystal lattice and the impurities are distributed within the crystal lattice.

18. The process of claim 9, wherein the impurities comprise trace metal cations with an oxidation state of +2.

19. The process of claim 9, wherein the liquor rich in metal sulfate comprises a level of impurities lower than a level of impurities in the crystals rich in metal sulfate.

20. The process of claim 1, wherein the liquor rich in metal sulfate comprises a similar concentration of metal sulfate as the metal sulfate concentration in the metal sulfate-rich feed solution.

21. A counter-current wash circuit for removing impurities from crystallized metal sulfate, the counter-current wash circuit comprising:
a plurality of washing tanks configured to receive crystallized metal sulfate in a sequence and a washing liquor in reverse of the select sequence, each washing tank coupled to a solid/liquid separation apparatus for separating the crystallized metal sulfate from the washing liquor, wherein the crystallized metal sulfate of a given washing tank is advanced to the next washing tank in the sequence and the washing liquor from said given washing tank is advanced to the previous washing tank in the sequence.

22. The counter-current wash circuit of claim 21, wherein each washing tank is configured to contact the crystallized metal sulfate and the washing liquor for a specified residence time.

23. The counter-current wash circuit of claim 21, wherein the washing liquor for the last washing tank in the sequence is water.

24. The counter-current wash circuit of claim 21, wherein the washing liquor for the first washing tank in the sequence is to be recycled to a metal sulfate crystallizer.

25. The counter-current wash circuit of claim 21, wherein the crystallized metal sulfate defines a crystal lattice and the impurities are distributed within the crystal lattice.

26. The counter-current wash circuit of claim 21, wherein the impurities comprise trace metal cations with an oxidation state of +2.

27. The process of claim 1, further comprising:
crystallizing a metal sulfate from an aqueous solution to form the crystallized metal sulfate in a mother liquor, the mother liquor comprising an uncrystallized metal sulfate;
separating the crystallized metal sulfate from the mother liquor;
basifying a portion of the mother liquor to convert the uncrystallized metal sulfate to a basic metal salt; and
using the basic metal salt upstream of crystallizing the metal sulfate.

28. The process of claim 9, further comprising:
basifying at least a portion of the overflow solution to convert uncrystallized metal sulfate to a basic metal salt; and
using the basic metal salt upstream of crystallizing the metal sulfate.

29. A process for generating a metal sulfate, the process comprising:
crystallizing a metal sulfate from an aqueous solution to form a crystallized metal sulfate in a mother liquor, the mother liquor comprising an uncrystallized metal sulfate;
separating the crystallized metal sulfate from the mother liquor;
contacting the crystallized metal sulfate with a liquor rich in metal sulfate to remove impurities from the crystallized metal sulfate;
basifying a portion of the mother liquor to convert the uncrystallized metal sulfate to a basic metal salt; and
using the basic metal salt upstream of crystallizing the metal sulfate.

30. The process of claim 29, wherein contacting the crystallized metal sulfate with a liquor rich in metal sulfate thereby forms a liquor containing metal sulfate and impurities, and the process further comprises:
basifying a portion of the liquor containing metal sulfate and impurities to convert the metal sulfate to a basic metal salt.
